(19) United States
(12) Patent Application Publication
(10) Pub. No.: US 2014/0320752 A1
(43) Pub. Date: Oct. 30, 2014

(54) TELEVISION AND ELECTRONIC APPARATUS

(71) Applicant: Kabushiki Kaisha Toshiba, Tokyo (JP)

(72) Inventors: Hirokazu Kawasaki, Fussa-shi (JP); Keiichi Mitsui, Kokubunji-shi (JP)

(73) Assignee: KABUSHIKI KAISHA TOSHIBA, Tokyo (JP)

(21) Appl. No.: 14/065,223

(22) Filed: Oct. 28, 2013

(30) Foreign Application Priority Data
Apr. 24, 2013 (JP) 2013-091501

(51) Int. Cl. H04N 5/655

(52) U.S. Cl. CPC H04N 5/655
USPC 348/836

(57) ABSTRACT

According to one embodiment, an electronic apparatus includes a housing, a display in the housing, and electronic components in the housing. The display includes a display surface configured to display an image. The housing includes a first cover, a second cover, and a third cover. The first cover includes a display opening exposing the display surface. The second cover is attached to the first cover and includes a covered surface. The covered surface includes openings configured to expose the electronic components and to allow the electronic components to pass therethrough. The third cover is attached to the second cover. The third cover covers the openings and at least a part of the covered surface.

### CROSS-REFERENCE TO RELATED APPLICATIONS

This application is based upon and claims the benefit of priority from Japanese Patent Application No. 2013-091501, filed Apr. 24, 2013, the entire contents of which are incorporated herein by reference.

### FIELD

Embodiments described herein relate generally to televisions and electronic apparatuses.

### BACKGROUND

An electronic apparatus such as a television comprises a housing and various components in the housing.

The housing gives an influence to an aesthetic appearance of the electronic apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view showing a television according to a first embodiment;

FIG. 2 is an exemplary rear view showing the television according to the first embodiment;

FIG. 3 is an exemplary right side view showing the television according to the first embodiment;

FIG. 4 is an exemplary left side view showing the television according to the first embodiment;

FIG. 5 is an exemplary plan view showing the television according to the first embodiment;

FIG. 6 is an exemplary bottom view showing the television according to the first embodiment;

FIG. 7 is an exemplary rear view showing the television according to the first embodiment excluding a main rear cover and a sub-rear cover;

FIG. 8 is an exemplary rear view showing an inside of the television according to the first embodiment excluding a rear frame;

FIG. 9 is an exemplary cross-sectional view showing a part of the television according to the first embodiment; and

FIG. 10 is an exemplary front view showing the main rear cover according to the first embodiment.

### DETAILED DESCRIPTION

Various embodiments will be described hereinafter with reference to the accompanying drawings.

In general, according to one embodiment, an electronic apparatus comprises a housing, a display in the housing, and electronic components in the housing. The display comprises a display surface configured to display an image. The housing comprises a first cover, a second cover, and a third cover. The first cover comprises a display opening exposing the display surface. The second cover is attached to the first cover and comprises a covered surface. The covered surface comprises openings configured to expose the electronic components and to allow the electronic components to pass therethrough. The third cover is attached to the second cover. The third cover covers the openings and at least a part of the covered surface.

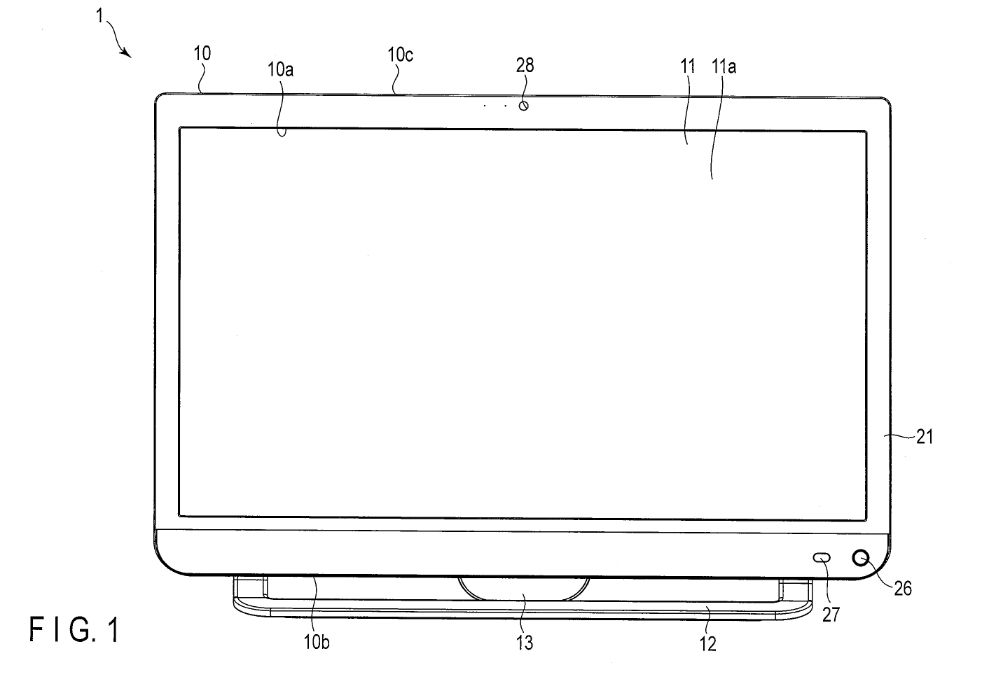

An embodiment will be described hereinafter with reference to FIG. 1 to FIG. 10. In the present specification, a near side (i.e., a user side) is defined as “front side”, a far side seen from a user is defined as “rear side”, a left side seen from the user is defined as “left side”, a right side seen from the user is defined as “right side”, an upper side seen from the user is defined as “upper side”, and a lower side seen from the user is defined as “lower side”. Furthermore, some components are expressed by two or more terms. Those terms are just examples. Those components may be further expressed by another or other terms. The other components which are not expressed by two or more terms may be expressed by another or other terms. Each drawing schematically shows the embodiment. Dimensions of each of the components shown in the drawings may be different from those in the description of the embodiment.

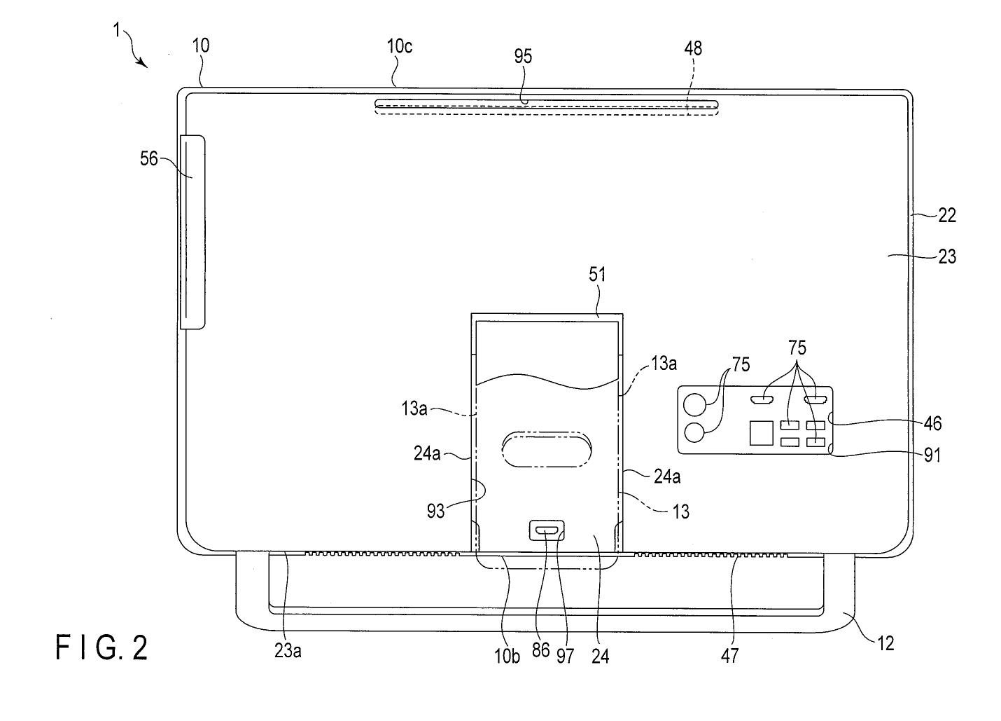

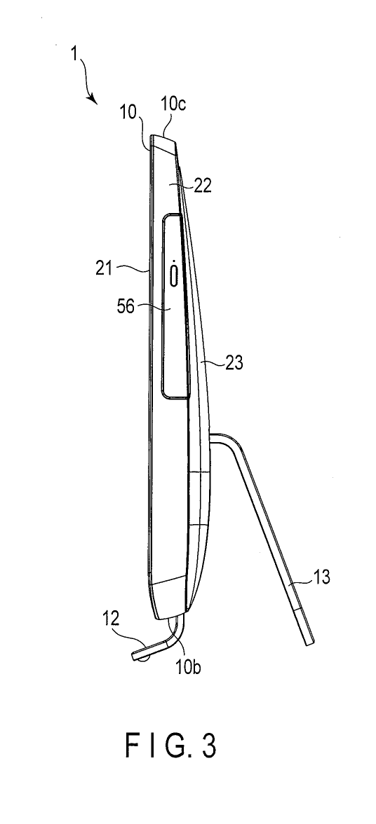

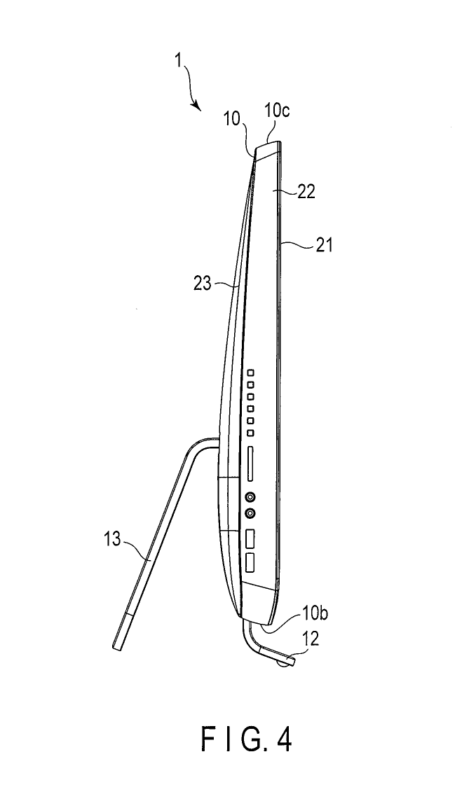

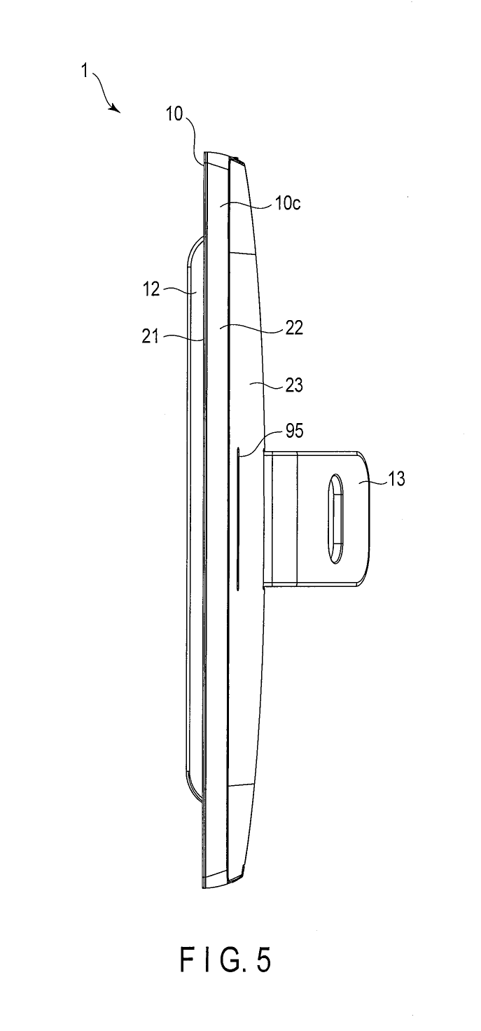

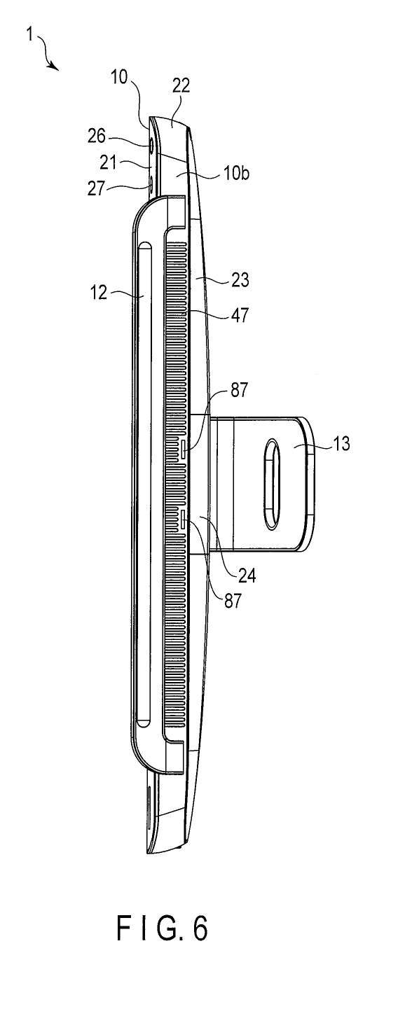

FIG. 1 is a front view of a television receiving apparatus (hereinafter, referred to as a television) 1 according to a first embodiment. FIG. 2 is a rear view of the television 1. FIG. 3 is a right side view of the television 1. FIG. 4 is a left side view of the television 1. FIG. 5 is a plan view of the television 1. FIG. 6 is a bottom of the television 1.

The television 1 is an example of an electronic apparatus. The electronic apparatus is not limited to the television 1, but may also be various apparatuses such as a personal computer, a display device (i.e., monitor), a cell phone, a smartphone, a game machine or a car navigation system.

As shown in FIG. 1, the television 1 is a liquid crystal television. The television 1 is used as not only a television receiving apparatus, but also a personal computer. For example, in the television 1, a program for a television receiving apparatus or an operation system for a personal computer is activated by a user operation. The television 1 may comprise a function as a television receiving apparatus alone.

The television 1 comprises a housing 10, a liquid crystal display (LCD) 11, a first stand 12 and a second stand 13. The housing 10 may also be called a cover, a cabinet, an exterior portion, a casing or a wall portion. The first stand 12 may also be called a front stand. The second stand 13 is an example of a stand and may also be called a rear stand, a support portion or a foot.

The LCD 11 is an example of a display and may also be called a display, a component, a module or a unit. The display is not limited to the LCD 11, but may also be other displays such as an organic EL display.

The LCD 11 is formed in a shape of a rectangular plate and comprises a display surface 11a which images are displayed on. In the present specification, the images include moving images and still images. The LCD 11 is accommodated in the housing 10.

The housing 10 comprises a display opening 10a through which at least a part of the display surface 11a is exposed. The display opening 10a is closed by, for example, transparent glass or an acrylic plate. The user can watch images displayed on the display surface 11a through the glass or the acrylic plate, and the display opening 10a.

The LCD 11 comprises a touch panel. The user can operate the television 1 by, for example, touching the display surface 11a of the LCD 11 through the glass or the acrylic plate.

The housing 10 comprises a front cover 21, a rear frame 22 and a main rear cover 23 as shown in FIG. 3. The housing 10 further comprises a sub-rear cover 24 as shown in FIG. 2. In FIG. 2, a part of the second stand 13 is represented by a two-dot-chained line to present the sub-rear cover 24.

The front cover 21 is an example of a first cover. The rear frame 22 is an example of a second cover. The main rear cover 23 is an example of a third cover. The sub-rear cover 24 is an example of a fourth cover. Each of the front cover 21, the rear frame 22, the main rear cover 23 and the sub-rear cover 24 may also be called a cover, a cabinet, an exterior portion, and a casing or a wall portion.

The front cover 21 forms a front surface of the housing 10 as shown in FIG. 1. The front cover 21 comprises the above-mentioned display opening 10a. The front cover 21 is further provided with a power button 26, a signal receiving unit 27 and a camera opening 28. The power button 26 is used for, for example, activation of the television 1. The signal receiving unit 27 is configured to receive, for example, an infrared signal emitted from a remote controller. The camera opening 28 allows a lens of a camera housed in the housing 10 to be exposed.

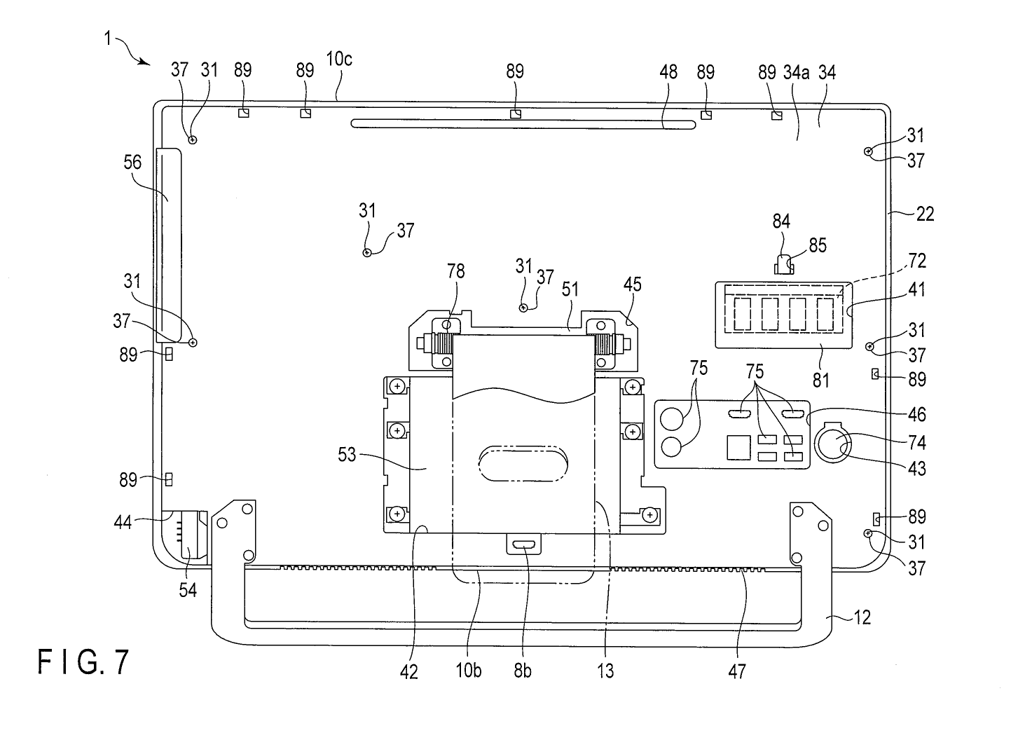

FIG. 7 is a rear view of the television 1 excluding the main rear cover 23 and the sub-rear cover 24. As shown in FIG. 7, the rear frame 22 forms a lower end 10b, an upper end 10c, a left end and a right end of the housing 10. In other words, the rear frame 22 comprises a peripheral wall of the housing 10 which protrudes from an outer edge of the front cover 21. When the television 1 is placed on, for example, a top surface (i.e., placement surface) of a table, the lower end 10b of the housing 10 faces the placement surface.

The rear frame 22 is fixed on the front cover 21 by, for example, a plurality of screws 31. A space to accommodate various components is formed inside the combined front cover 21 and rear frame 22.

The rear frame 22 comprises a wall portion 34 (i.e., wall). The wall portion 34 faces the front cover 21 and the LCD 11. The LCD 11 is positioned between the front cover 21 and the wall portion 34.

The wall portion 34 comprises a covered surface 34a. The covered surface 34a faces an outside of the television 1. In other words, the covered surface 34a faces an opposite side of the front cover 21. The covered surface 34a is not limited to a plane, but may also be, for example, a curved surface or an uneven surface.

The covered surface 34a is provided with a plurality of screw holes 37 (i.e., fixing members). The screw holes 37 are an example of holes and may also be called, for example, apertures, openings or insertion holes. The screws 31 are inserted into the screw holes 37 to fix the rear frame 22 on the front cover 21.

The rear frame 22 further comprises a memory opening 41, a storage opening 42, an RTC battery opening 43, a receiver opening 44, a stand opening 45, a connector opening 46, an air intake 47 and a first discharge hole 48.

The memory opening 41, the RTC battery opening 43 and the receiver opening 44 are examples of openings. The storage opening 42 is an example of an opening and is an example of a first exposing portion. The first discharge hole 48 is an example of a first ventilation hole.

The memory opening 41, the storage opening 42, the RTC battery opening 43, the receiver opening 44, the stand opening 45, the connector opening 46, and the first discharge hole 48 are provided on the covered surface 34a of the wall portion 34. The air intake 47 is formed at the lower end 10b of the housing 10.

The memory opening 41, the storage opening 42, the RTC battery opening 43, the receiver opening 44, the stand opening 45, the connector opening 46, the air intake 47 and the first discharge hole 48 open to the space formed inside the front cover 21 and the rear frame 22.

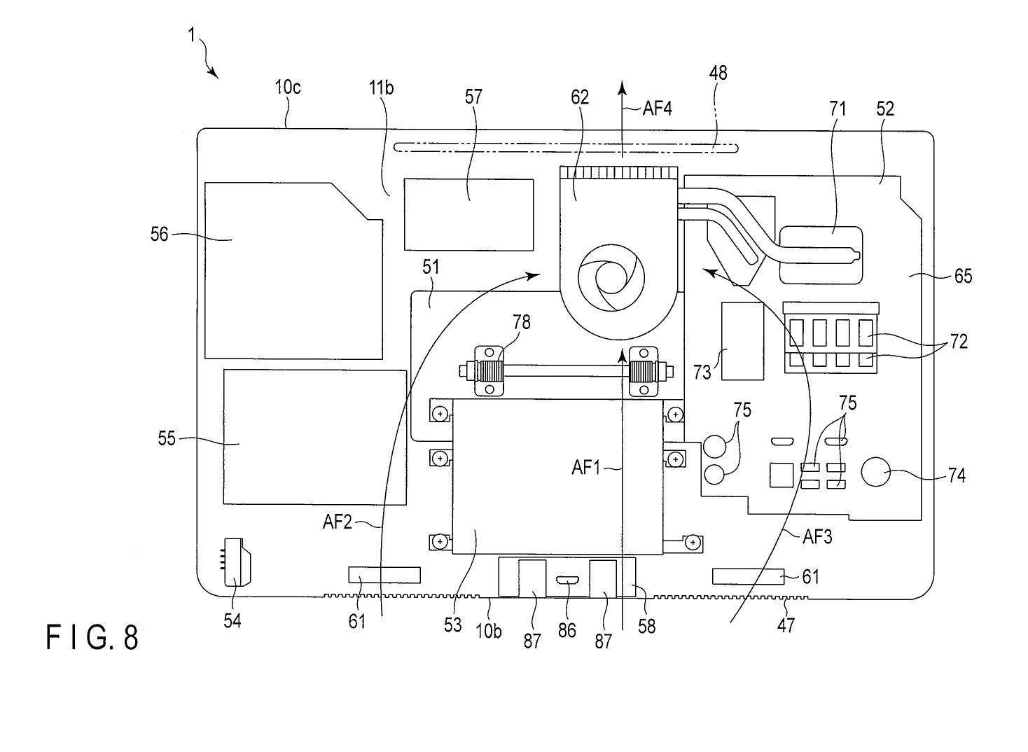

FIG. 8 is a rear view showing an inside of the television 1 excluding the rear frame 22. As shown in FIG. 8, the television 1 comprises a stand attachment portion 51, a printed circuit board (PCB) 52, a hard disk drive (HDD) 53, a receiver 54, a television board 55, an optical disk drive (ODD) 56, a touch panel control board 57, a sub-board 58, a pair of speakers 61 and a fan 62. The HDD 53 is an example of an electronic component or a component comprising a casing. The receiver 54 is an example of an electronic component.

The stand attachment portion 51, the PCB 52, the HDD 53, the receiver 54, the television board 55, the ODD 56, the touch panel control board 57, the sub-board 58, the pair of speakers 61 and the fan 62 are housed in the housing 10 and are overlaid on a back surface 11b of the LCD 11. The back surface 11b of the LCD 11 is positioned on an opposite side of the display surface 11a.

The PCB 52 comprises a mounting surface 65. The mounting surface 65 faces an opposite side of the LCD 11. In other words, the mounting surface 65 faces the wall portion 34 of the rear frame 22.

A CPU 71, two memories 72, a TV tuner 73, an RTC battery 74, and a plurality of connectors 75 are mounted on the mounting surface 65 of the PCB 52. The memories 72 and the RTC battery 74 are examples of electronic components.

The stand attachment portion 51 is a metal plate attached to a substantially central portion of the back surface 11b of the LCD 11. The stand attachment portion 51 comprises a hinge 78. An end of the second stand 13 is rotatably attached to the hinge 78 as shown in FIG. 7.

The stand opening 45 is provided at a position corresponding to the stand attachment portion 51. The stand opening 45 allows a part of the stand attachment portion 51 to be exposed. The second stand 13 protrudes from the covered surface 34a of the wall portion 34 through the stand opening 45. In other words, the stand opening 45 is an example of a position where the stand protrudes from the covered surface.

The second stand 13 is formed in a shape of a rectangular plate. The second stand 13 extends toward the lower side of the television 1. In other words, the second stand 13 extends so as to cover a component between the stand attachment portion 51 and the lower end 10b of the housing 10.

As shown in FIG. 8, the PCB 52 is arranged at a left side (e.g., right side in FIG. 8) of the stand attachment portion 51. The PCB 52 is provided from a substantially lower end to a substantially upper end of the housing 10. The PCB 52 is connected to the HDD 53, the receiver 54, the television board 55, the ODD 56, the touch panel control board 57, the sub-board 58, the speakers 61 and the fan 62 by, for example, a plurality of cables.

The two memories 72 overlap at least partially each other and are mounted on the PCB 52 so as to be detachable therefrom. As shown in FIG. 7, the memory opening 41 is provided at a position corresponding to the memories 72. The memory opening 41 allows at least a part of the memories 72 to be exposed. The memory opening 41 is formed in a size which allows the memories 72 to pass therethrough. The memory opening 41 does not need to be greater than the memories 72, but may be formed so as to allow, for example, the memories 72 tilted to the wall portion 34 to pass therethrough.

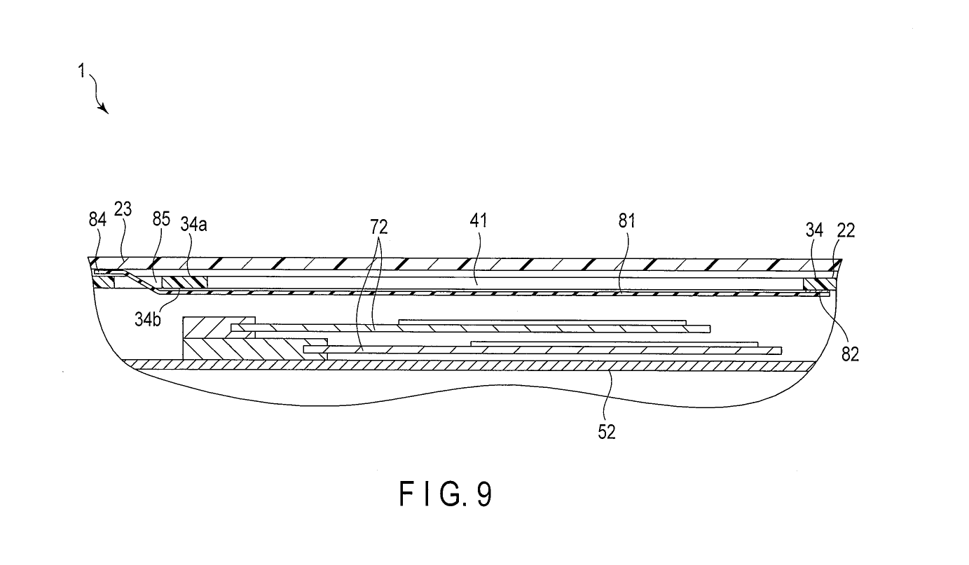

FIG. 9 is a cross-sectional view showing a part of the television 1 in the vicinity of the memories 72. As shown in FIG. 9, a lid 81 is attached to the wall portion 34 of the rear frame 22. The lid 81 is, for example, a rectangular sheet having flexibility.

One end of the lid 81 is fixed to an inner surface 34b of the wall portion 34 by a double-faced tape 82. The inner surface 34b of the wall portion 34 is positioned at an opposite side of the covered surface 34a. The lid 81 covers the memory opening 41 from inside the housing 10. The lid 81 thereby covers the memories 72 exposed through the memory opening 41.

The lid 81 can exit to an outside of the rear frame 22 through the memory opening 41 by being bent. If the lid 81 is pulled to the outside of the rear frame 22, the memories 72 are exposed through the memory opening 41.

The lid 81 comprises a tab 84. The tab 84 is provided at an end positioned opposite to the end of the lid 81 attached to the wall portion 34. The wall portion 34 comprises an engaging hole 85 provided at a position corresponding to the tab 84. The tab 84 is inserted into the engaging hole 85. The lid 81 is thereby held in a state of covering the memory opening 41.

As shown in FIG. 7, the RTC battery 74 is a disc-shaped battery and is attached to the PCB 52 so as to be detachable therefrom. The RTC battery opening 43 is provided at a position corresponding to the RTC battery 74. The RTC battery opening 43 allows the RTC battery 74 to be exposed. The RTC battery opening 43 is formed in a size which allows the RTC battery 74 to pass therethrough.

The plurality of connectors 75 are, for example, antenna terminals, USB connectors or HDMI connectors. The connector opening 46 is provided at a position corresponding to the plurality of connectors 75. The plurality of connectors 75 are exposed through the connector opening 46.

The HDD 53 is positioned between the lower end 10b of the housing 10, and the stand attachment portion 51 and the stand opening 45, in a height direction of the television 1 (i.e., a direction from the lower end 10b to the upper end 10c of the housing 10).

The HDD 53 is, for example, a component formed by housing a board, a plurality of magnetic disks and components for reading information from the magnetic disks in a casing. The component comprising a casing may be not limited to the HDD 53, but may also be other components such as an SSD.

The storage opening 42 is provided at a position corresponding to the HDD 53. The storage opening 42 allows the HDD 53 to be exposed therethrough. The storage opening 42 is formed in a size which allows the HDD 53 to pass therethrough.

The receiver 54 is configured to receive, for example, a wireless signal from a keyboard or a mouse. The receiver opening 44 is provided at a position corresponding to the receiver 54. The receiver opening 44 allows the receiver 54 to be exposed therethrough. The receiver opening 44 is formed in a size which allows the HDD 53 to pass therethrough.

As shown in FIG. 8, the sub-board 58 is arranged between the HDD 53 and the lower end 10b of the housing 10 in the height direction of the television 1. An HDMI connector 86 and two card connectors 87 are mounted on the sub-board 58. Components mounted on the sub-board 58 are not limited to these.

The HDMI connector 86 is arranged between the two card connectors 87. For example, B-CAS cards are inserted into the two card connectors 87. As shown in FIG. 6, slots of the card connectors 87 are open at the lower end 10b of the housing 10.

As shown in FIG. 8, the fan 62 is arranged at the upper side of the stand attachment portion 51. The fan 62 is thermally connected to the CPU 71 by, for example, a heat pipe. The fan 62 makes an air flow to be generated inside the housing 10. The fan 62 takes in air from the lower side, the left side and the right side and blows the air toward the upper side.

A part of the PCB 52, the television board 55, the ODD 56, the touch panel control board 57, the sub-board 58, the speakers 61, the fan 62, the CPU 71 and the TV tuner 73 are covered by the rear frame 22. These components may be exposed through, for example, holes provided on the rear frame 22.

As shown in FIG. 2, the main rear cover 23 and the sub-rear cover 24 are attached to the covered surface 34a of the rear frame 22. For this reason, the main rear cover 23 and the sub-rear cover 24 cover the covered surface 34a.

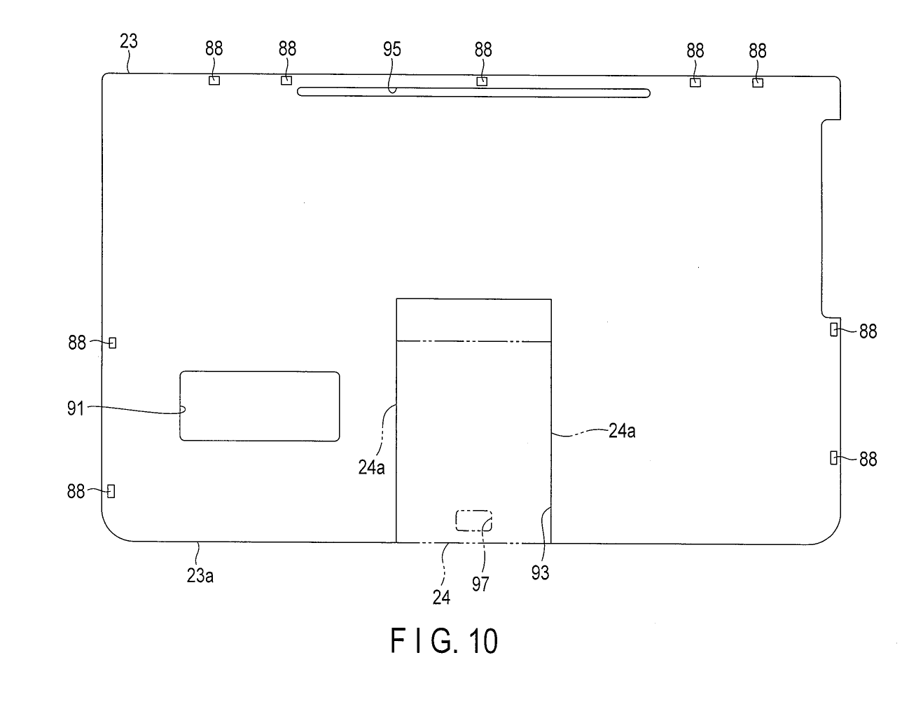

FIG. 10 is a front view showing the main rear cover 23. In FIG. 10, the sub-rear cover 24 is represented by a two-dot-chained line. As shown in FIG. 10, the main rear cover 23 comprises a plurality of latches 88 (e.g., claws). The latches 88 are examples of first engaging portions.

As shown in FIG. 7, a plurality of engaging holes 89 are provided on the covered surface 34a of the rear frame 22. The engaging holes 89 are examples of second engaging portions. The main rear cover 23 is attached to the covered surface 34a by engaging the latches 88 with the corresponding engaging holes 89. The main rear cover 23 is attached to the rear frame 22 by only engagement between the latches 88 and the engaging holes 89.

As shown in FIG. 2, the main rear cover 23 covers the plurality of screw holes 37, the memory opening 41, a part of the storage opening 42, the RTC battery opening 43, the receiver opening 44, a part of the stand opening 45, the engaging hole 85, and the plurality of engaging holes 89. The main rear cover 23 further covers the lid 81 which covers the memory opening 41 as shown in FIG. 9.

As shown in FIG. 2, the main rear cover 23 comprises a connector exposure opening 91. The connector exposure opening 91 is an opening provided at a position corresponding to the plurality of connectors 75. The plurality of connectors 75 are exposed through the connector opening 46 of the rear frame 22 and the connector exposure opening 91 of the main rear cover 23. In other words, the connector opening 46 and the connector exposure opening 91 communicate with each other.

The main rear cover 23 further comprises a storage exposure opening 93. The storage exposure opening 93 is an example of a second exposing portion. The storage exposure opening 93 is a rectangular cutout extending from a lower end 23a of the main rear cover 23 toward a substantially central portion of the main rear cover 23. In other words, the storage exposure opening 93 is a cutout opened from an outer edge of the main rear cover 23.

The storage exposure opening 93 is provided at a position corresponding to the stand attachment portion 51 and the HDD 53. The storage exposure opening 93 allows a part of the stand attachment portion 51 and a part of the HDD 53 to be exposed. In other words, the storage exposure opening 93 communicates with the storage opening 42 and the stand opening 45 of the rear frame 22. The second stand 13 protruding from the covered surface 34a of the wall portion 34 passes through the storage exposure opening 93.

The main rear cover 23 further comprises a second discharge hole 95. The second discharge hole 95 is provided at a position corresponding to the first discharge hole 48 of the rear frame 22. The second discharge hole 95 communicates with the first discharge hole 48. The second discharge hole 95 is an example of a second ventilation hole.

The first and second discharge holes 48 and 95 are provided near the upper end 10c of the housing 10. In other words, the first and second discharge holes 48 and 95 are positioned between the upper end 10c of the housing 10 and the fan 62 in the height direction of the housing 10.

The sub-rear cover 24 is fitted into the storage exposure opening 93. The sub-rear cover 24 is attached to the rear frame 22 by only engagement between the latches and the engaging holes, similarly to the main rear cover 23.

The sub-rear cover 24 closes a part of the storage opening 42 and a part of the storage exposure opening 93. By being fitted into the storage exposure opening 93, the sub-rear cover 24 forms a hole which the second stand 13 passes through.

The sub-rear cover 24 comprises a connector hole 97. The connector hole 97 is provided at a position corresponding to the HDMI connector 86 of the sub-board 58. The connector hole 97 allows the HDMI connector 86 to be exposed.

The second stand 13 overlaps with the sub-rear cover 24. A width of the sub-rear cover 24 is substantially equal to a width of the second stand 13. In other words, a pair of side edges 24a of the sub-rear cover 24 is provided at a position which substantially overlaps a pair of side edges 13a of the second stand 13.

As shown in FIG. 7, the first stand 12 is fixed on the rear frame 22. The first stand 12 comprises a portion extending to the lower side from the rear frame 22 and a portion extending along the lower end 10b of the housing 10.

The first stand 12 and the second stand 13 are to be placed on the placement surface, and support the housing 10 and a component such as the LCD 11 housed in the housing 10. In other words, the first stand 12 and the second stand 13 support a main body of the television 1.

An inside of the housing 10 is cooled by the fan 62, for example, as follows. The fan 62 cools the CPU 71 via the heat pipe. In addition, the fan 62 cools various electronic components inside the housing 10 by causing an air flow inside the housing 10.

As indicated by arrows in FIG. 8, when the fan 62 is driven, air flows (e.g., intake air) AF1, AF2 and AF3 heading toward the fan 62 are generated. Air flows generated by the fan 62 are not limited to the air flows AF1, AF2 and AF3.

The air flows AF1, AF2 and AF3 flow into the inside of the housing 10 from the air intake 47 provided at the lower end 10b of the housing 10. In some space, cold air exists at the lower side, and warm air exists at the upper side. Thus, relatively cold air flows into the inside of the housing 10.

The air flow AF1 passes through a gap between the sub-board 58 and the wall portion 34, a gap between the HDD 53 and the wall portion 34, and a gap between the stand attachment portion 51 and the wall portion 34, and flows into the fan 62. The air flow AF1 cools a heat-generating electronic component such as the HDD 53.

The air flow AF2 passes over the television board 55 and near the touch panel control board 57, and flows into the fan 62. The air flow AF2 cools a heat-generating electronic component such as a tuner provided on the television board 55.

The air flow AF3 passes over the PCB 52 and flows into the fan 62. The air flow AF3 cools a heat-generating electronic component such as the CPU 71, the memories 72 and the TV tuner 73.

The fan 62 is further configured to make an air flow (e.g., exhaust) AF4 discharged from the fan 62. The air flow AF4 passes through the first discharge hole 48 of the rear frame 22 and the second discharge hole 95 of the main rear cover 23, and is discharged out of the housing 10. Thus, the television 1 takes in air from the air intake 47 provided at the lower end 10b of the housing 10 and discharges the air from the first and second discharge holes 48 and 95 provided at the upper end 10c of the housing 10.

The memory opening 41, the storage opening 42, the RTC battery opening 43, the receiver opening 44, and a part of the stand opening 45 are covered by the main rear cover 23 and the sub-rear cover 24. Thus, the air flows generated by the fan 62 are prevented from leaking from these openings. In other words, the main rear cover 23 and the sub-rear cover 24 blocks air leakage from the above openings.

A gap may exist between the main rear cover 23 and the sub-rear cover 24, and the covered surface 34a of the rear frame 22. In this case, a part of an air flow passing between the front cover 21 and the rear frame 22 escapes from the memory opening 41, the storage opening 42, the RTC battery opening 43, the receiver opening 44, the stand opening 45 and the connector opening 46. The escaping air flow passes through the gap between the main rear cover 23 and the sub-rear cover 24, and the covered surface 34a of the rear frame 22. The air flow escapes out of the housing 10 from the second discharge hole 95 of the main rear cover 23 with an air flow escaping from the first discharge hole 48 of the rear frame 22. In other words, channels through which hot air generated by a heat-generating electronic component such as the HDD 53 escapes out of the housing 10 are increased.

For example, an electronic component such as the HDD 53, the receiver 54, the memories 72 and the RTC battery 74 which the television 1 comprises, is replaced by an operator when being broken, or is replaced by a user for performance improvement.

When the electronic component is replaced, the main rear cover 23 and the sub-rear cover 24 are taken off from the rear frame 22. The memory opening 41, the storage opening 42, the RTC battery opening 43 and the receiver opening 44 are thereby exposed.

If the HDD 53 is replaced, for example, a screw which fixes the HDD 53 on the inside of the housing 10 is taken off from the HDD 53. The HDD 53 is removed from the inside of the housing 10 through the storage opening 42, and instead a new HDD 53 is mounted on the inside of the housing 10 through the storage opening 42.

If the memories 72 are replaced, the tab 84 of the lid 81 is taken off from the engaging hole 85. The lid 81 is taken out of the memory opening 41, and thereby the memories 72 are exposed. The memories 72 are removed from the inside of the housing 10 through the memory opening 41, and instead new memories 72 are mounted in the PCB 52 through the memory opening 41.

According to the television 1 of the first embodiment, a plurality of openings such as the memory opening 41 and the RTC battery opening 43 are provided on the covered surface 34a of the rear frame 22. The openings are used for attachment and removal of an electronic component such as the memories 72 and the RTC battery 74, and allow the electronic component to be exposed and to pass therethrough.

The above plurality of openings such as the memory opening 41 and the RTC battery opening 43 are covered by the single main rear cover 23. It is therefore unnecessary, for example, to provide a plurality of doors which cover the above plurality of openings, respectively, in the television 1.

If the doors covering the respective openings are provided, a slit between the openings and the doors (e.g., gap between inner edges of the openings and outer edges of the doors) and asperities are generated. Such a slit and asperities may reduce an aesthetic appearance of the television 1. However, in the television 1 of the first embodiment, since the single main rear cover 23 covers the plurality of openings as described above, it is unnecessary to provide the plurality of doors. Thus, the slit and the asperities which reduce the aesthetic appearance of the television 1 are prevented from being generated, and the aesthetic appearance of the television 1 is improved.

Moreover, if a plurality of electronic components such as the memories 72 and the RTC battery 74 are replaced, a plurality of openings such as the memory opening 41 and the RTC battery opening 43 are exposed simply by taking off the main rear cover 23 from the rear frame 22. In other words, for example, it is unnecessary to take off the respective doors from the plurality of openings. Simply by taking off the single main rear cover 23 from the rear frame 22, the plurality of openings are opened at once. Thereby, electronic components such as the memories 72 and the RTC battery 74 can be easily replaced and a maintainability of the television 1 is improved.

The fan 62 is arranged inside the housing 10, and the air flows generated by the fan 62 pass through the first and second discharge holes 48 and 95, which are provided on the rear frame 22 and the main rear cover 23, respectively. Thus, electronic components such as the HDD 53 and the memories 72 within the housing 10 are cooled by the air flows.

Moreover, since the single main rear cover 23 covers a plurality of openings such as the memory opening 41 and the RTC battery opening 43, retention of air caused due to accumulation of dust is restricted. More specifically, if the doors close the openings, air may leak from the gap between the inner edges of the openings and the outer edges of the doors. In this case, dust easily accumulates in the gap. If dust accumulates, air flows are interrupted by the dust, and cooling efficiency inside the housing 10 is decreased. However, in the television 1 of the first embodiment, the single main rear cover 23 covers the plurality of openings. This restricts occurrence of a gap where dust easily accumulates. Accordingly, retention of air due to accumulation of dust is restricted, and the electronic components inside the housing 10 are effectively cooled by the air flows. Moreover, the television 1 can be easily cleaned.

The main rear cover 23 is attached to the rear frame 22 by only engagement between the latches 88 and the engaging holes 89. Thus, the main rear cover 23 is restricted from being provided with, for example, a screw hole which damages the aesthetic appearance of the television 1, and the aesthetic appearance of the television 1 is improved.

Furthermore, since the main rear cover 23 is attached to the rear frame 22 by only engagement, a gap easily occurs between the main rear cover 23 and the rear frame 22 in comparison with a case where the main rear cover 23 is attached by, for example, screws. Together with air, heat generated by an electronic component such as the HDD 53 and the memories 72 can escape from the gap through an opening such as the memory opening 41 and the storage opening 42. Thus, the inside of the housing 10 is well cooled.

The HDD 53 comprising a casing is positioned between the lower end 10b of the housing 10 and the stand attachment portion 51. In other words, the HDD 53, which is relatively heavy due to the casing, is positioned at the lower side of the television 1, and the center of gravity of the television 1 is brought lower.

The HDD 53 positioned between the lower end 10b of the housing 10 and the stand attachment portion 51 is exposed through the storage opening 42 and the storage exposure opening 93 which are provided on the rear frame 22 and the main rear cover 23, respectively. The sub-rear cover 24 closes the storage opening 42 and the storage exposure opening 93.

For example, the HDMI connector 86 exists or does not exist in the television 1 in accordance with a type of the television 1. The sub-rear cover 24 is formed as a component separated from the main rear cover 23. Thus, the sub-rear cover 24 which comprises the connector hole 97 or the sub-rear cover 24 which does not comprise the connector hole 97 can be formed. By virtue of this, a production cost of the television 1 becomes lower in comparison with a case where the main rear cover 23 and the sub-rear cover 24 are integrally formed.

There is a possibility that dust accumulates in a gap between an inner edge of the storage exposure opening 93 and an outer edge of the sub-rear cover 24. However, since the HDD 53 comprises the casing, it is hardly affected by a temperature rise due to the dust, as compared with, for example, the memories 72 which do not comprise a casing. A trouble of the television 1 is thereby prevented.

The rear frame 22 is fixed on the front cover 21 with the screws 31. The screw holes 37 which the screws 31 pass through may damage the aesthetic appearance of the television 1. However, the screw holes 37 are covered by the main rear cover 23. The aesthetic appearance of the television 1 is thereby improved.

Inside the main rear cover 23, the memory opening 41 is covered by the lid 81. Thus, for example, the memories 72 are prevented from being damaged by static electricity due to a careless touch of a user on the memories 72 when the main rear cover 23 is taken off.

The storage exposure opening 93 which the second stand 13 pass through is the cutout opened from the outer edge of the main rear cover 23. Thus, even if the second stand 13 protrudes from the covered surface 34a of the rear frame 22, the main rear cover 23 can be easily attached to the rear frame 22.

The pair of side edges 24a of the sub-rear cover 24 is provided at a position which substantially overlaps the pair of side edges 13a of the second stand 13. Thus, even if the sub-rear cover 24 is provided, the gap between the inner edge of the storage exposure opening 93 and the side edges 24a of the sub-rear cover 24 is inconspicuous. The aesthetic appearance of the television 1 is thereby improved.

Next, a second embodiment will be described. In the embodiment described hereinafter, components which have the same functions as those of the television 1 of the first embodiment are designated by the same reference numbers as those of the first embodiment. Explanations of the components may be omitted in part or in whole.

A shape and an arrangement of the television 1 of the second embodiment are the same as those of the television 1 of the first embodiment. Thus, the second embodiment will be described with reference to FIG. 1 to FIG. 10 showing the first embodiment. A sub-rear cover 24 of the second embodiment faces an HDD 53 through a storage opening 42 and a storage exposure opening 93.

The sub-rear cover 24 is formed of a member which is softer than a main rear cover 23. In other words, the sub-rear cover 24 of the second embodiment is an example of a buffer. The sub-rear cover 24 may comprise a buffer such as a sponge and rubber which is separated from the sub-rear cover 24.

The sub-rear cover 24 of the second embodiment faces the HDD 53 and is softer than the main rear cover 23. The HDD 53 is thereby prevented from being damaged by shock.

According to at least one of the televisions described above, a single third cover covers a plurality of openings through which an electronic component is exposed and through which the electronic component can pass. Thus, aesthetic appearances of the television reception apparatuses are improved.

For example, as shown in FIG. 2, the main rear cover 23 of the first embodiment comprises a cutout which a portion (e.g., bezel) of an exposed ODD 56 is fitted into. By arranging the bezel of the ODD 56 such that the bezel is in contact with a boundary between the front cover 21 and the rear frame 22 shown in FIG. 3, the cutout can be omitted from the main rear cover 23. The main rear cover 23 like this can further improve the aesthetic appearance of the television 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a housing;
a display in the housing, the display comprising a display surface configured to display an image;
electronic components in the housing;
a fan in the housing, the fan configured to make an air flow inside the housing;
a stand supporting the housing and the display; and
a component in the housing, the component comprising a casing,
wherein the housing comprises:
a first cover comprising a display opening exposing the display surface;
a second cover attached to the first cover, the second cover comprising
a covered surface comprising openings, a first ventilation hole and a hole, the openings configured to expose the electronic components and to allow the electronic components to pass therethrough, the air flow generated by the fan passes through the first ventilation hole,
a first engaging portion, and
a first exposing portion configured to expose the component;
a lid covering one of the openings;
a fixing member inserted into the hole and fixing the second cover on the first cover;
a third cover comprising a second engaging portion engaging with the first engaging portion, a second exposing portion configured to expose the component, and a second ventilation hole communicating with the first ventilation hole, the third cover attached to the second cover by only engagement between the first engaging portion and the second engaging portion, the third cover covering at least a part of the covered surface, the openings, the hole and the lid; and
a fourth cover attached to the second cover, the fourth cover covering the first exposing portion and the second exposing portion and comprising a buffer, the buffer facing the component comprising the casing, the buffer being softer than the third cover,
wherein the stand protrudes from the covered surface and passes through the second exposing portion,
the component comprising the casing is located between a lower end of the housing and a position where the stand protrudes from the covered surface, and
the second exposing portion of the third cover is a cutout opened from an outer edge of the third cover.

2. An electronic apparatus comprising:
a housing;
a display in the housing, the display comprising a display surface configured to display an image;
electronic components in the housing;
wherein the housing comprises:
a first cover comprising a display opening exposing the display surface;
a second cover attached to the first cover and comprising a covered surface, the covered surface comprising openings configured to expose the electronic components and to allow the electronic components to pass therethrough; and
a third cover attached to the second cover, the third cover covering the openings and at least a part of the covered surface.

3. The apparatus of claim 2, further comprising
a fan in the housing, the fan configured to make an air flow inside the housing,
wherein the covered surface comprises a first ventilation hole through which the air flow generated by the fan passes, and
the third cover comprises a second ventilation hole communicating with the first ventilation hole.

4. The apparatus of claim 3,
wherein the second cover comprises a first engaging portion, and
the third cover comprises a second engaging portion engaging with the first engaging portion, and the third cover is attached to the second cover by only engagement between the first engaging portion and the second engaging portion.

5. The apparatus of claim 4, further comprising:
a stand protruding from the covered surface and supporting the housing and the display; and
a component in the housing, the component comprising a casing and located between a lower end of the housing and a position where the stand protrudes from the covered surface.

6. The apparatus of claim 5, further comprising
a fourth cover attached to the second cover,
wherein the second cover comprises a first exposing portion configured to expose the component,
the third cover comprises a second exposing portion configured to expose the component, and
the fourth cover covers at least a part of the first exposing portion and at least a part of the second exposing portion.

7. The apparatus of claim 6, further comprising
a fixing member fixing the second cover on the first cover,
wherein the covered surface of the second cover comprises a hole into which the fixing member is inserted, and
the third cover covers the hole.

8. The apparatus of claim 7, further comprising
a lid covering at least one of the openings and covered by the third cover.

9. The apparatus of claim 8,
wherein the second exposing portion of the third cover is a cutout opened from an outer edge of the third cover, and
the stand passes through the second exposing portion.

10. The apparatus of claim 8,
wherein the fourth cover comprises a buffer facing the component comprising the casing, the buffer being softer than the third cover.
